(19) United States
(12) Patent Application Publication
(10) Pub. No.: US 2024/0252393 A1
(43) Pub. Date: Aug. 1, 2024

(54) Portable Tactile Transducer Therapeutic Table

(71) Applicant: Mario Roberts, COSTA MESA, CA (US)

(72) Inventor: Mario Roberts, COSTA MESA, CA (US)

(21) Appl. No.: 18/516,162

(22) Filed: Nov. 21, 2023

Related U.S. Application Data
(60) Provisional application No. 63/482,034, filed on Jan. 28, 2023.

(51) Int. Cl. A61H 23/02

(52) U.S. Cl. CPC A61H 23/0218; A61H 2201/0138; A61H 2201/0146; A61H 2201/0157; A61H 2201/5005; A61H 2203/0456; A61H 2205/062; A61H 2205/081; A61H 2205/10

(57) ABSTRACT

Embodiments of the present disclosure may include a portable therapeutic system comprises a table embedded with tactile transducers that deliver vibrational energy to key areas of a user's body. Once laid atop the table, the user's spine, shoulder blades, tailbone, and legs contact transducers preferably positioned around the underneath of the table length. The transducers receive input signals from an amplifier and convert these into finely calibrated vibrations. Users or practitioners may select frequencies targeting specific health conditions to promote overall wellness. The full-body delivery of these curated vibrations allows for resonance between the body and stimulating frequencies to potentially realign energies, reduce inflammation, relax muscles, and restore sleep, depending on the selected program. The invention provides non-invasive access to customizable vibrational therapy designed to rejuvenate the body and mind.

### FIELD OF INVENTION

The present invention relates to synchronized tactile transducers embedded in a portable table apparatus to deliver customized, full-body vibrational therapy sessions targeting relaxation, pain relief, and other wellness goals.

### BACKGROUND OF THE INVENTION

Tactile transducers represent an innovative technology with untapped therapeutic potential. Also known as bass shakers, these devices convert electrical signals into vibrational energy using the principles of electromagnetism. The transducer contains a permanent magnet surrounded by a coil. When an audio input passes through the coil, it creates a changing magnetic field that makes the magnet oscillate rapidly. The resulting vibrations can be precisely controlled and safely transmitted to the human body for customized wellness applications.

Mounting tactile transducers on surfaces contacting key areas of the body allows users to physically experience the oscillating stimulation. This full-body delivery method shows promise for resonance-based therapies that leverage frequencies to restore health and harmony. The concept has roots in the field of vibroacoustic therapy. This uses low frequency sound waves and vibrations to “entrain” the body's cells, tissues, and organs to emit desired frequencies associated with beneficial states.

Modern implementations of vibroacoustic therapy show measurable impacts on conditions such as chronic pain, neuropathy, PTSD, and more. Clinical studies on the use of tactile transducers to deliver such focused vibrations are still emerging, but initial results indicate similar potential upsides. The underlying mechanism relates to activating mechanoreceptors in the skin, muscles, and joints. The pressure and motion signals from these receptors link to regions of the brain involved in regulating pain, emotion, and homeostasis. Gentle stimulation appears to release neurotransmitters like serotonin and dopamine critical for feelings of relaxation, well-being, and deep sleep.

A key advantage of using tactile transducers for therapy is the non-invasive delivery method with minimal side effects. The vibrational energy can be targeted to specific body areas and tailored to individual needs. No drugs or invasive procedures are required. The technology is safe and effective when calibrated and controlled properly. It also enables self-administered care with proper guidance. As components continue to miniaturize, tactile transducers may unlock convenient at-home solutions for certain therapies.

While promising, substantiating the benefits depends on continued scientific rigor to better understand treatment mechanisms, dosages, and long-term impacts. Each condition requires unique protocols backed by statistical evidence and user studies. Promising areas to target include back pain, fibrotic diseases, neuropathy, spinal cord injuries, insomnia, and more. If efficacy is proven, integrating tactile transducers into cost-effective treatment plans could make the benefits accessible to more patients.

Undoubtedly, tactile transducer technology has strong foundations but remains underexplored in therapeutic applications. The non-invasive vibrational energy delivery mechanism appeals as an alternative or supplement to traditional rehabilitation practices. It is therefore an object of the current invention to realize the full wellness potential of this technology, in a manner that can pave the way for innovative biofeedback solutions using these compact, versatile devices.

### SUMMARY OF THE INVENTION

The following summary is an explanation of some of the general inventive steps for the invention in the description. This summary is not an extensive overview of the invention and does not intend to limit its scope beyond what is described and claimed as a summary.

Embodiments of the present disclosure may include a portable bed or table system including a table with numerous tactile transducers arranged to come into contact with a user's body along the spine, shoulder blades, tailbone and legs to vibrate or oscillate the body to various therapeutic sounds and vibrations to calm the body and harmonize the cells, stimulate neurons and to help regenerate and heal the body and mind.

In an exemplary arrangement, the tactile transducers, equipped with electromagnets, rapidly oscillate in response to audio signals transmitted through them via wire connections. The result is finely calibrated vibrational energy that interacts with the body's mechanoreceptors where contact is made.

In some embodiments, the system may include an amplifier that can be connected to the tactile transducers, allowing for Bluetooth, analogue or digital sound input. In some embodiments, the system, further employing the entrainment principle, which may be the frequency locking of two oscillating bodies, to expose the body and mind to certain frequencies that allow the cells to harmonize to the exposing frequencies causing the body to become healthier. In certain aspects, introducing specific frequencies through the tactile transducers, the cells in the user's body can resonate in alignment with these nurturing frequencies, potentially promoting regeneration and healing.

Embodiments of the present disclosure may also include, the table including tactile transducers along a left channel and a right channel and being connected to a power source.

Embodiments of the present disclosure may also include, the tactile transducers positioned around the underneath of the table to produce an oscillating effect around the body. Strategically positioning transducers around the underside of the table, creates an oscillating effect that envelops the user's entire body.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is a perspective view of the portable therapeutic table, according to one embodiment of the present disclosure.

FIG. 2 is a top view of the portable therapeutic table with a person receiving therapy.

FIG. 3 is a top view of the portable therapeutic table with a person receiving therapy.

FIG. 4 is side view of the portable therapeutic table according to one aspect.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

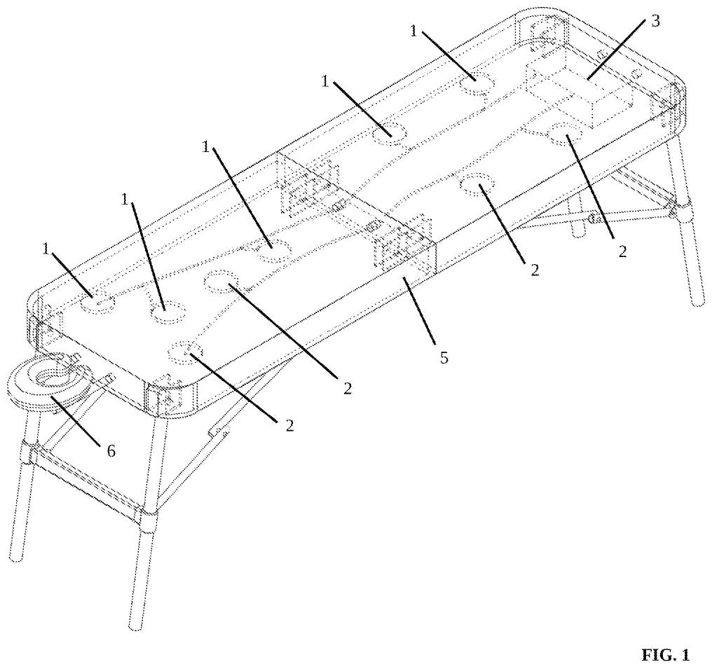

The present invention as illustrated by the non-limiting embodiment of FIG. 1 relates to a portable bed or table system designed to provide therapeutic benefits through the use of tactile transducers. Specifically, FIG. 1 is a perspective view of the portable therapeutic table, according to one embodiment of the present disclosure. It illustrates a therapeutic system uniquely designed to deliver customized vibrational energy throughout a user's body. The system comprises a portable table structure 5 with an ergonomic profile preferably including headrest 6 to comfortably support individuals during full-body treatment sessions. Embedded within the cushioned table are numerous tactile transducers along a left channel 1 and a right channel 2, and may be connected to a power source. The transducers may be strategically positioned to make contact with key areas along the back, shoulders, hips, and legs.

These transducers of FIG. 1 contain electromagnets that oscillate rapidly when audio signals are sent through them via wire connections. This generates precise vibrational energy that can be felt by the body's mechanoreceptors where contact is made. The locations are selected based on maximizing delivery of the vibrations to large muscle groups and nerve clusters for whole-body impact.

The input signals driving the tactile transducers originate from amplifier 3. This device allows practitioners to control and tailor the frequency, amplitude, waveform, and duration of the vibrations being produced. The amplifier may include pre-programmed settings designed to target specific health goals like relaxation, pain relief, and sleep aid. However, and without limitation, complete manual control is also possible for advanced customization.

The amplifier 3 connects to the left 1 and right 2 banks of embedded transducers, allowing different vibration patterns to be emitted on each side of the user simultaneously. This unlocks numerous possible arrays of potential therapeutic combinations. The amplifier may also have Bluetooth connectivity, analog and digital audio inputs to allow audio files or streams to be used as input.

A working principle that may be leveraged in the system is entrainment—the synchronization of oscillations between two objects. It is believed that healthy cells in the body vibrate at certain natural resonant frequencies. By using the table to introduce these nurturing frequencies through the tactile transducers, the cells can be entrained to recalibrate to healthy vibratory states. This resonance effect can purportedly aid regeneration and healing.

In various embodiments, a user may select a desired therapeutic frequency through the amplifier and the transducers will vibrate or oscillate the body to that frequency. The vibrations and sounds produced by the tactile transducers may be useful for calming the body and harmonizing the cells, stimulating neurons and helping regenerate and heal the body and mind. In the figure, it is shown the tactile transducers may be positioned around the underneath of the table to produce an oscillating effect around the body.

The disclosed full-body vibrational therapy is non-invasive with minimal side effects in most users. It requires no drugs or cumbersome equipment. Sessions on the table simply involve relaxing comfortably while allowing the tailored vibrations to stimulate circulation, loosen muscles, activate pressure points, and potentially harmonize the body's energy. Preferably, guided programs make it simple and possible to enjoy the benefits. Generally, the FIG. 1 showcases an embodiment of a portable table invention designed to resonate rejuvenating vibrational frequencies throughout the user's body. Strategically placed tactile transducers driven by a customizable amplifier provide accessible and non-invasive means to experience full-body vibrational therapy.

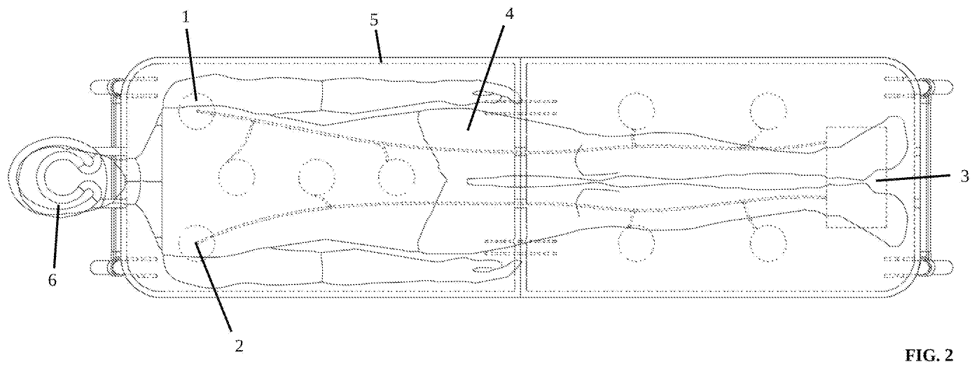

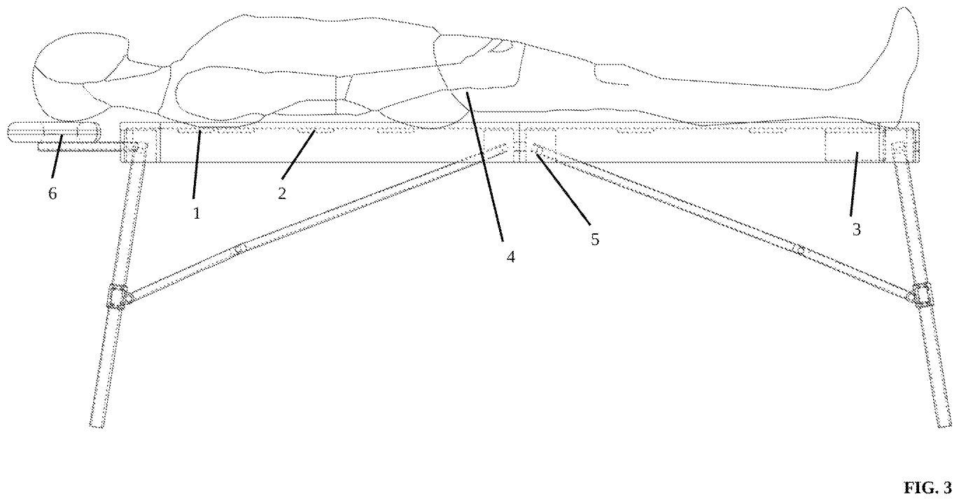

Reference is now made to FIG. 2 and FIG. 3 of the drawings, wherein FIG. 2 is a top view of the portable therapeutic table with a person receiving therapy and FIG. 3 is a top view of the portable therapeutic table with a person receiving therapy.

As shown in FIG. 2, the therapeutic system is prepared for use by placing the portable table 5 with embedded tactile transducers 1 and 2 preferably atop a flat surface. The user 4 then lies down atop the cushioned surface of table 5, allowing their body to make contact with the table structure with embedded transducers on the left bank 1 and right bank 2. This disposition of the user brings the tactile transducers on the left and right channels into alignment with key areas including the legs, hips, back, and shoulders. The user may then rests their head on headrest 6 for optimal comfort throughout the session.

In some aspects, the therapy system leverages the principles of vibroacoustic therapy to deliver to the user 4 customized mechanical vibrations through the strategically placed transducers 1 and 2. The input signals driving the vibrations originate from amplifier 3, which may include pre-programmed therapeutic sequences or allow manual control of parameters like frequency, amplitude, and duration.

Further, and as depicted in FIG. 3, the amplifier 3 connects to the tactile transducers via wiring routed underneath table 5. In some aspects, the amplifier may also connect to headphones for an immersive audio-vibrational experience. An audio media source can provide sound input to complement the tactile vibrational therapy.

For tailored treatment, the user may select a pre-programmed sequence on amplifier 3 designed for their needs, such as back pain relief or improved sleep. The corresponding vibrational frequency pattern is then delivered through transducers 1 and 2, causing them to oscillate against the user's body. This aims to “entrain” the body's cells to resonate in healthy synchronization.

The non-invasive delivery of tailored vibrational therapy provides an accessible means to reduce pain, relax muscles, restore sleep, and holistically rejuvenate the body and mind. The table apparatus combines body support, targeted transducer placement, and customizable control to create an intuitive platform for vibrational treatments in professional or personal settings. The portable, mat-like form factor enhances convenience and ease-of-use.

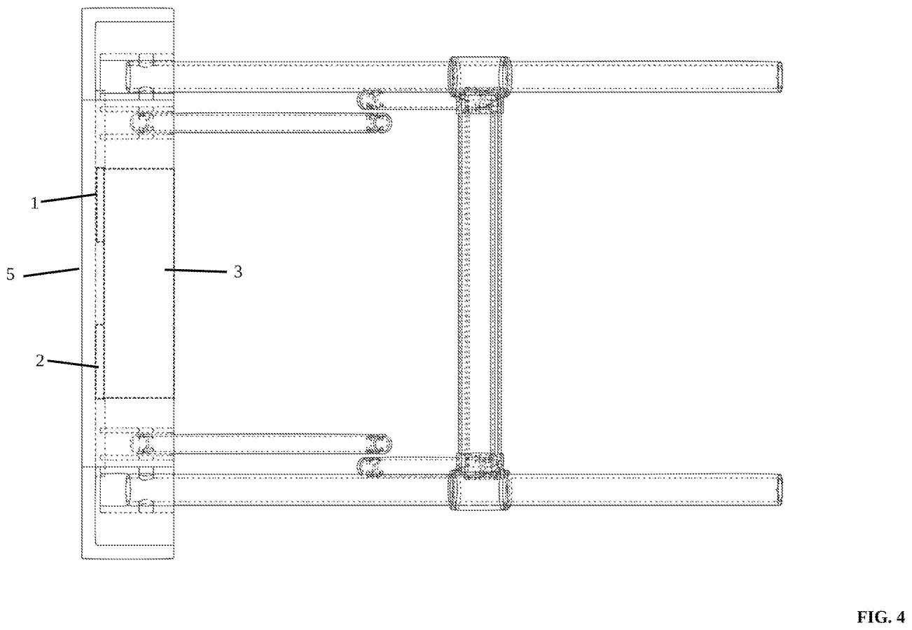

The FIG. 4, on the other hand is side view of the portable therapeutic table according to one aspect. On the figure it is shown a table structure 5 laid on its side, possibly in a storage position, where the amplifier 3 is seen on one end of the table. Also shown are the left 1 and right 2 banks of embedded transducers. In some aspects, the left bank 1 and right bank 2 of embedded transducers may be covered by a suitable cover for aesthetics, or to protet them from potential damage.

While a preferred embodiment of this invention has been described for illustrative purposes, it should be noted that this invention is not limited to the described embodiment, and those skilled in the art will recognize that various modifications, additions, and substitutions may be necessary or beneficial for this particular application, all of which remain within the scope and spirit of the invention as defined by the accompanying claims. The applicant acknowledges and anticipates such adjustments.

Consequently, the applicant intends to encompass all such alternative designs, modifications, equivalents, and variations that fall within the essence and scope of the disclosed subject matter, specifically tailored for this application. It is also important to recognize that references to items in singular form encompass items in plural form, and vice versa, unless explicitly stated otherwise or evident from the context.

Grammatical conjunctions are used to denote both disjunctive and conjunctive combinations of conjoined clauses, sentences, words, and the like, unless otherwise specified or evident from the context.

Use of singular or plural terms is meant to encompass all options, unless explicitly limited. The term “or” in particular implies “and/or” except where otherwise indicated.

### INDUSTRIAL APPLICATION

The disclosed invention has versatile applications across the wellness industry. It is well-suited for spas, physical therapy offices, hospitals, and clinics seeking to augment services with non-invasive, resonance-based relaxation and rejuvenation treatments. The portable table design also enables potential in-home use for continued personal therapy and supplemental pain relief.

What is claimed is:

1. A therapeutic system comprising: a portable table apparatus with a plurality of tactile transducers embedded within said table and positioned to transmit vibrations to key areas along a user's spine, shoulder blades, tailbone, and legs when in contact, wherein the plurality of tactile transducers are synchronized by a central control unit to vibrate in phase with one another.

2. The system of claim 1, further comprising an amplifier connected to said plurality of tactile transducers to provide input signals of selected frequencies and amplitudes to control the vibrations produced.

3. The system of claim 2, wherein the amplifier includes controls allowing adjustment of vibration frequency, duration, and sequencing to provide customized vibrational therapy programs.

4. The system of claim 1, wherein the tactile transducers are arranged within left and right channels of the table apparatus corresponding to the left and right sides of a user's body.

5. The system of claim 1, further comprising a power source to provide electricity to the amplifier and tactile transducers.

6. The system of claim 1, wherein the table apparatus comprises a padded mattress layer atop a rigid undersurface structure for the embedded tactile transducers.

7. The system of claim 1, further comprising adjustable mounts securing the embedded tactile transducers at calibrated points along the table apparatus.

8. The system of claim 1, wherein the tactile transducers are configured to produce transverse oscillating vibrations perpendicular to the surface of the table apparatus.

9. A method for delivering therapeutic vibrations comprising:
positioning a user atop a table apparatus comprising embedded tactile transducers;
activating the tactile transducers to produce synchronized vibrations; and
transmitting the synchronized vibrations transversely into the user's body along key areas in contact with the table apparatus.

10. The method of claim 9 further comprising:
connecting an amplifier to the tactile transducers; selecting a vibration frequency and amplitude at the amplifier; and
delivering signals at the selected frequency and amplitude from the amplifier to the tactile transducers.

11. The method of claim 9 wherein the key areas comprise locations along the user's spine, shoulder blades, tailbone, and legs.

12. The method of claim 9, further comprising executing a series of vibration sequences through the tactile transducers by adjusting frequency and amplitude over time.

13. The method of claim 12, wherein the series is selected from predetermined programs targeting therapeutic goals including relaxation, pain relief, and sleep aid.

14. The method of claim 9 wherein synchronizing the tactile transducers comprises triggering each transducer simultaneously through a central control unit.

15. The method of claim 9 further comprising securing the user atop the table apparatus in a fixed position during delivery of the vibrations.
